(19) United States
(12) Patent Application Publication
(10) Pub. No.: US 2026/0200327 A1
(43) Pub. Date: Jul. 16, 2026

(54) PANTOGRAPH BOUNCE LOGIC

(71) Applicant: Cummins Power Generation Inc., Minneapolis, MN (US)

(72) Inventors: Latif M. Shaikh, Pune (IN); Anand Narayan Jarudkar, Pune (IN); Amit Balkrishna Sonpethkar, Pune (IN); Sushant Petare, Pune (IN); Vysakh M, Alappuzha (IN)

(73) Assignee: Cummins Power Generation Inc., Minneapolis, MN (US)

(21) Appl. No.: 19/128,510

(22) PCT Filed: Nov. 10, 2023
(86) PCT No.: PCT/US2023/079407

§ 371 Date: May 8, 2025

(30) Foreign Application Priority Data
Nov. 11, 2022 (IN) 202241064689

(51) Int. Cl. B60L 3/00; B60L 1/00; B60L 3/04; B60L 5/24; B60L 9/00

(52) U.S. Cl. CPC B60L 3/0061; B60L 1/00; B60L 3/04; B60L 5/24; B60L 9/005; B60L 2200/26; B60L 2210/20; B60L 2240/526; B60L 2240/527; B60L 2240/529; B60L 2240/80

(57) ABSTRACT

Systems and apparatuses include one or more processing circuits comprising one or more memory devices coupled to one or more processors, the one or more memory devices configured to store instructions thereon that, when executed by the one or more processors, cause the one or more processors to: determine a pantograph bounce event based on an input voltage and an input voltage frequency; automatically disable a rectifier in response to determining the pantograph bounce event; record an instant DC link voltage at the time the rectifier is disabled; and set a reference DC voltage to the instant DC link voltage.

### CROSS REFERENCE TO RELATED APPLICATIONS

The present application claims the benefit of priority to Indian Provisional Patent Application No. 202241064689, titled “PANTOGRAPH BOUNCE LOGIC,” filed Nov. 11, 2022, which is incorporated by reference in its entirety.

### BACKGROUND

The present disclosure relates generally to pantograph bounce logic. More specifically, the present disclosure relates to pantograph bounce logic for a hotel load converter used in railway applications.

### SUMMARY

One embodiment relates to a pantograph bounce logic system that includes one or more processing circuits comprising one or more memory devices coupled to one or more processors, the one or more memory devices configured to store instructions thereon that, when executed by the one or more processors, cause the one or more processors to: determine a pantograph bounce event based on an input voltage and an input voltage frequency, automatically disable a rectifier in response to determining the pantograph bounce event, record a DC link voltage at the time the rectifier is disabled, and set a reference DC voltage to the DC link voltage.

At least one aspect of the present disclosure is directed to a system for protecting from pantograph bounce events. The system may include a pantograph disposed on a railway car. The pantograph may be structured to be electrically coupled with a contact wire to receive electric power from the contact wire. The system may include a hotel load converter (HLC) disposed in the railway car. The HLC may be structured to be electrically coupled with the pantograph. The HLC may include a power electronic component configured to perform alternating current (AC/AC) conversion on the electric power received via the contact wire from the railway car. The system may include a controller disposed in the railway car. The controller may be structured to be electrically coupled with the HLC. The controller may include a bounce circuit. The controller may identify, at an input of the HLC, a voltage and a frequency of the voltage of the electric power from the pantograph. The controller may determine that the voltage satisfies a voltage threshold and the frequency satisfies a frequency threshold. The controller may detect a bounce event in a connection between the pantograph and the contact wire providing the electric power based on the voltage satisfying the voltage threshold and the frequency satisfying the frequency threshold. The controller may disable, responsive to detecting the bounce event, the power electronic component in the HLC.

In some embodiments, the controller may determine, responsive to disabling the power electronic component, an instantaneous direct current (DC) link voltage at the input of the HLC. In some embodiments, the controller may set the power electronic component to a reference voltage using the instantaneous DC link voltage to continue operations of the power electronic component.

In some embodiments, the controller may determine, responsive to disabling the power electronic component, that a root-mean-squared (RMS) voltage is greater than a RMS voltage threshold and that the frequency is less than or equal to a second frequency threshold. In some embodiments, the controller may execute, responsive to determining that the RMS voltage is greater than the RMS voltage threshold and that the frequency is less than the second frequency threshold, a shutdown procedure on the HLC.

In some embodiments, the controller may determine, responsive to disabling the power electronic component, that a root-mean-squared (RMS) voltage drops to less than a RMS voltage threshold and that the frequency becomes within a target range, within a period of time. In some embodiments, the controller may resume, responsive to determining that the RMS voltage drops to less than the RMS voltage threshold and that the frequency becomes within the target range within the period of time, operations of the HLC.

In some embodiments, the controller may determine that the voltage does not satisfy the voltage threshold and frequency does not satisfy the frequency threshold. In some embodiments, the controller may identify a lack of the bounce event in the connection between the pantograph and the contact wire based on the voltage not satisfying the voltage threshold and the frequency not satisfying the frequency threshold. In some embodiments, the controller may continue, responsive to identifying the lack of the bounce event, operations of the power electronic component in the HLC.

In some embodiments, the HLC may in in accordance with at least one of a plurality of modes based at least on (i) a distance between the pantograph and the contact wire and (ii) the voltage at the input of the HLC. In some embodiments, the HLC may provide the electric power to a load on the railway car. The load may include at least one of: an entertainment system, a kitchen appliance, a refrigeration system, or a heating system for the railway car.

At least one aspect of the present disclosure is directed to a controller. The controller may include a bounce circuit comprising one or more processors coupled with memory. The bounce circuit may monitor, at an input of a hotel load converter (HLC), a voltage and a frequency of the voltage of electric power received by the HLC from a contact wire via a pantograph of a railway car. The bounce circuit may compare the voltage with a voltage threshold and the frequency of the voltage with a frequency threshold. The bounce circuit may determine an occurrence of a bounce event in a connection between the pantograph and the contact wire, responsive to the voltage satisfying the voltage threshold and the frequency satisfying the frequency threshold for a time exceeding a threshold period of time. The bounce circuit may disable, in response to determining the occurrence of the bounce event, a rectifier of the HLC.

In some embodiments, the bounce circuit may determine, responsive to disabling the rectifier, that a root-mean-squared (RMS) voltage is greater than a RMS voltage threshold and that the frequency is within a target range. In some embodiments, the bounce circuit may set, responsive to determining that the RMS voltage is greater than the RMS voltage threshold and the frequency is within the target range, the rectifier to a reference voltage using an instantaneous DC link voltage at the input of the HLC, to transition from the reference voltage to a nominal voltage.

In some embodiments, the bounce circuit may determine, responsive to disabling the rectifier, that a root-mean-squared (RMS) voltage is less than or equal to a RMS voltage threshold or that the frequency is outside a target range. In some embodiments, the bounce circuit may wait, responsive to determining that the RMS voltage is less than or equal to the RMS voltage threshold or the frequency is outside the target range, for a period of time for the frequency to become greater than a second frequency.

In some embodiments, the bounce circuit may reset, responsive to setting the rectifier to a reference voltage based on an instantaneous DC link voltage, a plurality of control loops of the rectifier. In some embodiments, the bounce circuit may enable, responsive to resetting of the plurality of control loops, the rectifier of the HLC to continue operations.

In some embodiments, the bounce circuit may determine, responsive to disabling the rectifier of the HLC, that a root-mean-squared (RMS) voltage is greater than a RMS voltage threshold and that the frequency is less than or equal to a second frequency threshold. In some embodiments, the bounce circuit may cause, responsive to determining that the RMS voltage is greater than the RMS voltage threshold and that the frequency is less than the second frequency threshold, the HLC to shut down.

In some embodiments, the bounce circuit may determine, responsive to disabling the rectifier, that a root-mean-squared (RMS) voltage drops to less than a RMS voltage threshold and that the frequency becomes within a target range, within a period of time. In some embodiments, the bounce circuit may resume, responsive to determining that the RMS voltage drops to less than the RMS voltage threshold and that the frequency becomes within the target range within the period of time, operations of the HLC.

At least one aspect of the present disclosure is directed to a method of providing continuous power through pantograph bounce events. The method may include monitoring, by a controller, at an input of a hotel load converter (HLC), a voltage and a frequency of the voltage of electric power received via a pantograph from a contact wire. The method may include determining, by the controller, that the voltage satisfies a voltage threshold and the frequency satisfies a frequency threshold. The method may include detecting, by the controller, a bounce event in a connection between the pantograph and the contact wire, responsive to determining the voltage satisfying the voltage threshold and the frequency satisfying the frequency threshold. The method may include performing, by the controller, responsive to detecting the bounce event, an operation on a power electronic component in the HLC.

In some embodiments, the method may include determining, by the controller, that a time elapsed since detection of the bounce event is less than a threshold time. In some embodiments, performing the operation may include performing an arc drawn mode to draw the electric power via the pantograph from the contact wire, responsive to determining that the time elapsed is less than the threshold time.

In some embodiments, the method may include determining, by the controller, that a time elapsed since detection of the bounce event is greater than or equal to a threshold time. In some embodiments, performing the operation may include performing an arc extinction mode to not draw the electric power via the pantograph from the contact wire, responsive to determining that the time elapsed is greater than or equal to the threshold time.

In some embodiments, the method may include detecting, by the controller, subsequent to detecting the bounce event, reestablishment of the connection between the pantograph and the contact wire. In some embodiments, the method may include performing, by the controller, an arc approach mode to draw the electric power via the pantograph from the contact wire, responsive to detecting the reestablishment of the connection subsequent to the bounce event.

In some embodiments, the method may include resetting, by the controller, responsive to setting the power electronic component to a reference voltage based on an instantaneous direct current (DC) link voltage at the input of the HLC, a plurality of control loops of the power electronic component. In some embodiments, the method may include enabling, by the controller, responsive to resetting of the plurality of control loops, the HLC to continue operations.

In some embodiments, the method may include determining, by the controller, that the voltage does not satisfy the voltage threshold and frequency does not satisfy the frequency threshold. In some embodiments, the method may include identifying, by the controller, a lack of the bounce event in the connection between the pantograph and the contact wire based on the voltage not satisfying the voltage threshold and the frequency not satisfying the frequency threshold. In some embodiments, the method may include continuing, by the controller, responsive to identifying the lack of the bounce event, operations of the power electronic component in the HLC.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a perspective view of a railcar including a pantograph and a hotel load converter, according to some embodiments.

FIG. 2 is a perspective view of the hotel load converter of FIG. 1, according to some embodiments.

FIG. 3 is an exploded view of the hotel load converter of FIG. 1, according to some embodiments.

FIG. 4 is a schematic diagram of the hotel load converter of FIG. 1, according to some embodiments.

FIG. 5 is a schematic diagram of a system for protecting from pantograph bounce events, according to some embodiments.

FIG. 6 is a schematic diagram showing pantograph bounce over time, according to some embodiments.

FIGS. 7A-C is a flow diagram of a method of providing continuous power through pantograph bounce events implemented by the controller of FIG. 5, according to some embodiments.

### DETAILED DESCRIPTION

Following below are more detailed descriptions of various concepts related to, and implementations of, methods, apparatuses, and systems for providing continuous service from a hotel load converter during a pantograph bounce event. Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

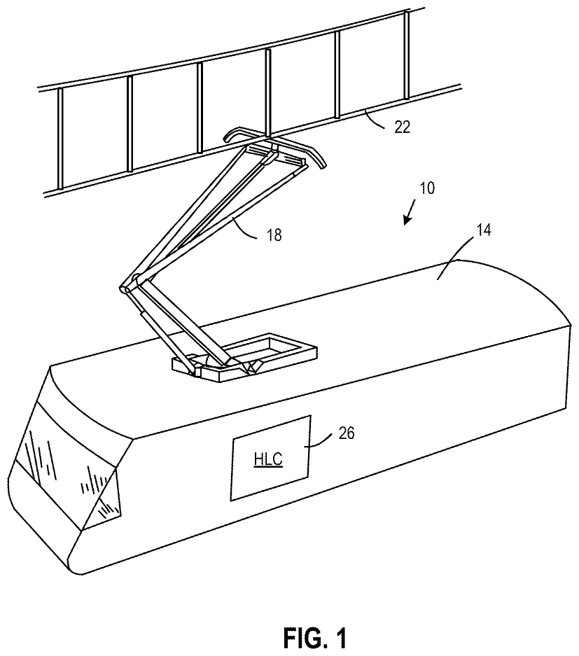

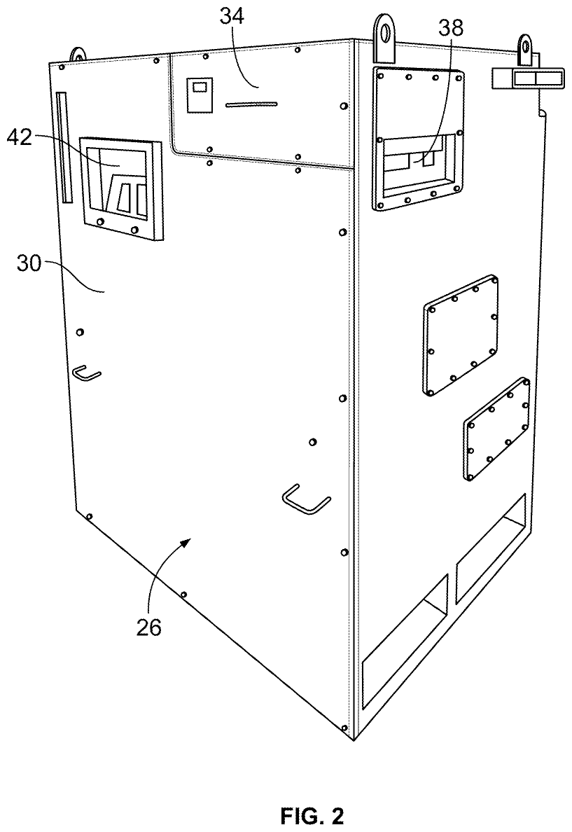

As shown in FIG. 1, a railway car 10 includes a body 14 that supports a pantograph 18. The pantograph 18 includes a set of articulated arms fixed to the body 14 (e.g., a roof) of the railway car 10 that unfold and extend along a vertical axis. A head of the pantograph 18 is fitted with carbon strips structured to engage a contact wire 22. The number and types of carbon strips can be adjusted based on the nature and intensity of the current to be transmitted (e.g., AC or DC). The pantograph 18 transmits power from the contact wire 22 to traction motors and a Hotel Load Converter (HLC) 26.

The HLC 26 is a 500 KW high voltage high power AC to AC converter which has two stages. A first stage converts AC to DC power, and a second stage converts the DC power received from the first stage to three phase AC power. Both the first stage and the second stage include power electronics modules which consists of high power high current insulated-gate bipolar transistor (IGBT) modules, high power bulk capacitors, current and voltages sensors, power electronics, and control boards. The HLC 26 is generally structured to receive power from the pantograph 18 and condition the power for use on the railway car 10 other than to drive the traction motors. For example, the HLC 26 may provide power to climate control (e.g., HVAC), kitchen, washing machines, entertainment systems, lighting, refrigeration systems, water heating systems, etc.

As shown in FIG. 2, the HLC 26 includes a frame 30 structured to support a controller 34 that controls operation of the HLC 26, a connector 38 that provides power from the HLC 26 to external systems of the railway car 10, and a human machine interface (HMI) 42 that allows an operator to interact with the HLC 26.

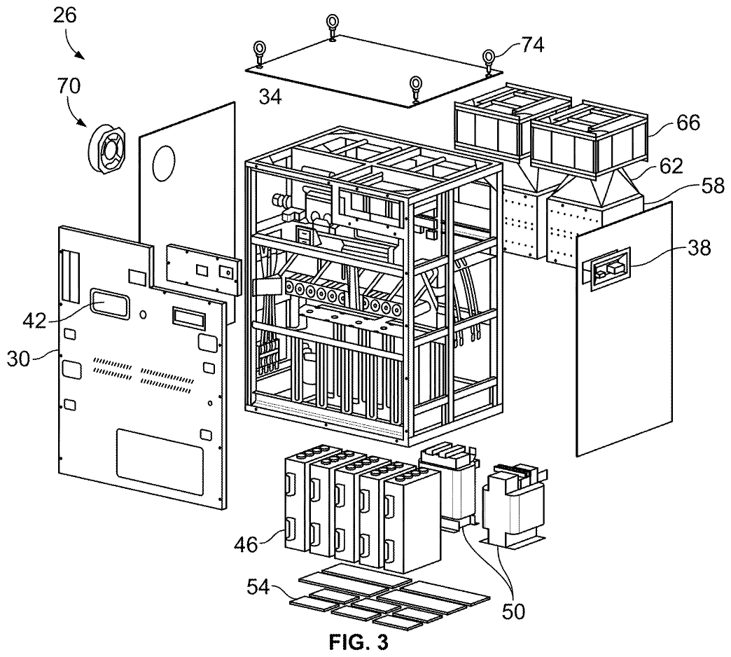

As shown in FIG. 3, the HLC 26 also includes a capacitor bank 46 and inductors 50 supported by bottom plates 54, and a cooling system for the capacitor bank 46 and inductors 50 that includes heat sinks 58, ducts 62, and blowers 66. The HLC 26 also includes a fan 70 for venting the HLC 26 and lifting hooks 74 that facilitate moving the HLC 26. In some embodiments, a different number of capacitors or inductors may be included. Similarly, the number and arrangement of heat sinks 58, ducts 62, and blowers 66 may be adjusted, as desired.

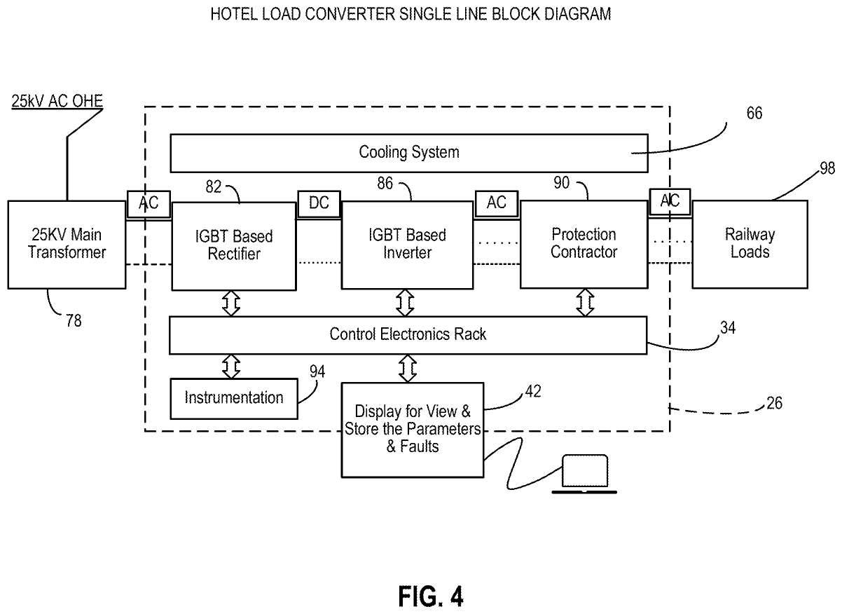

As shown in FIG. 4, the pantograph 18 provides power to a main transformer 78 of the railway car 10 and AC power is provided to the HLC 26. A rectifier 82 receives the AC power from the main transformer 78 and provides DC power to an inverter 86. The inverter 86 converts the DC from the rectifier 82 to three-phase AC power that is provided to a protection contactor 90. The protection contactor 90 is arranged in communication with loads 98 via the connector 38. The controller 34 communicates with and controls the rectifier 82, the inverter 86, and the protection contactor 90. The HLC 26 additionally includes instrumentation (e.g., sensors, shunts, actuators, switches, etc.) in communication with the controller 34. The HMI 42 provides a display and user interface for interaction with the controller 34. In some embodiments, the HMI 42 includes a network connection such as a modem, a network switch, a wireless network, a cloud based service accessible by an application, or another interface, as desired.

In some embodiments, an input voltage received by the rectifier 82 defines a minimum voltage of 633 VAC, a nominal voltage of 960 VAC, and a maximum voltage of 1190 VAC. In some embodiments, a DC bus voltage output by the rectifier 82 is desirably 1800 VDC. In some embodiments, a line voltage per phase of the three-phase AC output from the inverter 86 is 750 Vrms. In some embodiments, a frequency output of the inverter 86 is 50 Hz. In some embodiments, a voltage output of the inverter 86 is 500 KVA.

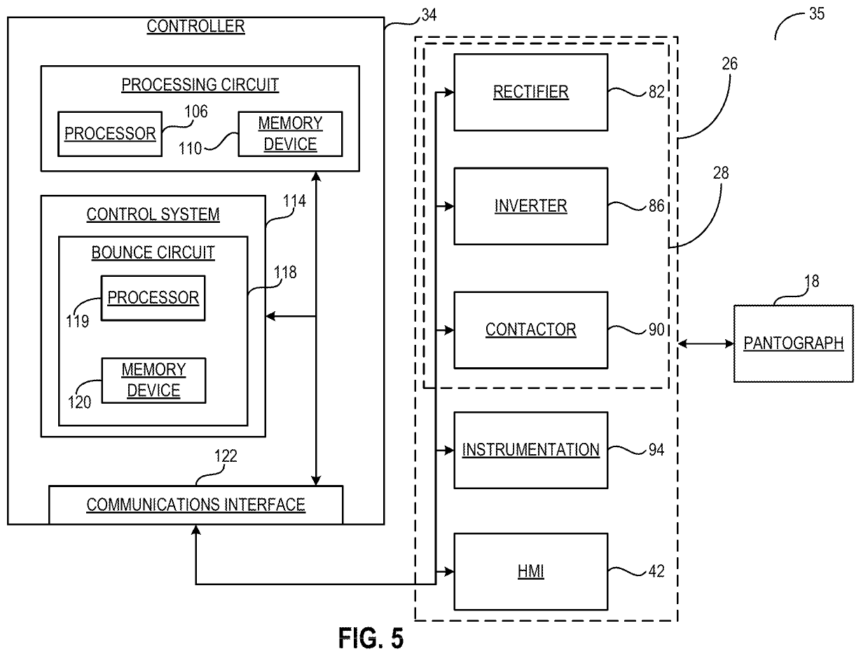

As the components of FIG. 1 are shown to be embodied in the railway car 10, the controller 34 may be separate from or included with at least one railway car controllers located outside the HLC 26. The function and structure of the controller 34 is described in greater detail in FIG. 5.

Referring now to FIG. 5, a schematic diagram of a system 35 for protecting from pantograph bounce events. The system 35 may include the controller 34 of the railway car 10 and the HLC 26 of FIG. 1. As shown, the controller 34 includes a processing circuit 102 having a processor 106 and a memory device 110, a control system 114 having a bounce circuit 118, and a communications interface 122. The bounce circuit 118 may include at least one or processor 119 and at least one memory device 120, among others. The controller 34 may be structured to be coupled with the HLC 26. The HLC 26 may include a set of power electronic components 26 (e.g., the rectifier 82, the inverter 86, and the contactor 90), the instrumentation 94, and HMI 42, among others. The communication interface 122 may communicate or exchange data with one or more components of the HLC 26, such as the rectifier 82, the inverter 86, the contactor 90, the instrumentation 94, and the HMI 42, among others. Generally, the controller 34 is structured to implement a pantograph bounce logic that improves the uninterrupted supply time to load in the absence of input voltage (e.g., during a bounce event).

In one configuration, the bounce circuit 118 are embodied as machine or computer-readable media that is executable by a processor, such as processor 119. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the bounce circuit 118 are embodied as hardware units, such as electronic control units. As such, the bounce circuit 118 may be embodied as one or more circuitry components including, but not limited to, processing circuitry, network interfaces, peripheral devices, input devices, output devices, sensors, etc. In some embodiments, the bounce circuit 118 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the bounce circuit 118 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The bounce circuit 118 may also include programmable hardware devices such as field programmable gate arrays, programmable array logic, programmable logic devices or the like. The bounce circuit 118 may include one or more memory devices for storing instructions that are executable by the processor(s) of the bounce circuit 118. The one or more memory devices and processor(s) may have the same definition as provided below with respect to the memory device 110 and processor 106. In some hardware unit configurations, the bounce circuit 118 may be geographically dispersed throughout separate locations in the vehicle. Alternatively and as shown, the bounce circuit 118 may be embodied in or within a single unit/housing, which is shown as the controller 34.

In the example shown, the controller 34 includes the processing circuit 102 having the processor 106 and the memory device 110. The processing circuit 102 may be structured or configured to execute or implement the instructions, commands, and/or control processes described herein with respect to bounce circuit 118. The depicted configuration represents the bounce circuit 118 as machine or computer-readable media. However, as mentioned above, this illustration is not meant to be limiting as the present disclosure contemplates other embodiments where the bounce circuit 118, or at least one circuit of the bounce circuit 118, is configured as a hardware unit. All such combinations and variations are intended to fall within the scope of the present disclosure.

The hardware and data processing components used to implement the various processes, operations, illustrative logics, logical blocks, modules and circuits described in connection with the embodiments disclosed herein (e.g., the processor 106) may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., bounce circuit 118 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 110 and 120 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 110 may be communicably connected to the processor 106 to provide computer code or instructions to the processor 106 for executing at least some of the processes described herein. Moreover, the memory device 110 may be or include tangible, non-transient volatile memory or non-volatile memory. Accordingly, the memory device 110 may include database components, object code components, script components, or any other type of information structure for supporting the various activities and information structures described herein. The bounce circuit 118 (or the control system 114 of which the bounce circuit 118 is a part of or the controller 34) is structured to implement a pantograph bounce logic as described below.

The system 35 may include the pantograph 18 disposed on a railway car 10. The pantograph 18 may be structured to be electrically coupled with a contact wire 22 to receive electric power from the contact wire 22. The system 35 may include the hotel load converter (HLC) 26 disposed in the railway car. The HLC 26 may be structured to be electrically coupled with the pantograph 18. The HLC 26 may include a power electronic component 28 (e.g., the rectifier 26) configured to perform alternating current (AC/AC) conversion on the electric power received via the contact wire 22 from the railway car. The system 35 may include the controller 34 disposed in the railway car. The controller 34 may be structured to be electrically coupled with the HLC 26.

The controller 34 may include the bounce circuit 118. The controller 34 may identify, at an input of the HLC 26, a voltage and a frequency of the voltage of the electric power from the pantograph 18. The controller 34 may determine that the voltage satisfies a voltage threshold and the frequency satisfies a frequency threshold. The controller 34 may detect a bounce event in a connection between the pantograph 18 and the contact wire 22 providing the electric power based on the voltage satisfying the voltage threshold and the frequency satisfying the frequency threshold. The controller 34 may disable, responsive to detecting the bounce event, the power electronic component 28 in the HLC 26.

In some embodiments, the controller 34 may determine, responsive to disabling the power electronic component 28, an instantaneous direct current (DC) link voltage at the input of the HLC 26. In some embodiments, the controller 34 may set the power electronic component 28 to a reference voltage using the instantaneous DC link voltage to continue operations of the power electronic component 28.

In some embodiments, the controller 34 may determine, responsive to disabling the power electronic component 28, that a root-mean-squared (RMS) voltage is greater than a RMS voltage threshold and that the frequency is less than or equal to a second frequency threshold. In some embodiments, the controller 34 may execute, responsive to determining that the RMS voltage is greater than the RMS voltage threshold and that the frequency is less than the second frequency threshold, a shutdown procedure on the HLC 26.

In some embodiments, the controller 34 may determine, responsive to disabling the power electronic component 28, that a root-mean-squared (RMS) voltage drops to less than a RMS voltage threshold and that the frequency becomes within a target range, within a period of time. In some embodiments, the controller 34 may resume, responsive to determining that the RMS voltage drops to less than the RMS voltage threshold and that the frequency becomes within the target range within the period of time, operations of the HLC 26.

In some embodiments, the controller 34 may determine that the voltage does not satisfy the voltage threshold and frequency does not satisfy the frequency threshold. In some embodiments, the controller 34 may identify a lack of the bounce event in the connection between the pantograph 18 and the contact wire 22 based on the voltage not satisfying the voltage threshold and the frequency not satisfying the frequency threshold. In some embodiments, the controller 34 may continue, responsive to identifying the lack of the bounce event, operations of the power electronic component 28 in the HLC 26.

In some embodiments, the HLC 26 may in in accordance with at least one of a plurality of modes based at least on (i) a distance between the pantograph 18 and the contact wire 22 and (ii) the voltage at the input of the HLC 26. In some embodiments, the HLC 26 may provide the electric power to a load on the railway car. The load may include at least one of: an entertainment system 35, a kitchen appliance, a refrigeration system 35, or a heating system 35 for the railway car.

At least one aspect of the present disclosure is directed to a controller 34. The controller 34 may include a bounce circuit 118 comprising one or more processors 119 coupled with memory 120. The bounce circuit 118 may monitor, at an input of a hotel load converter (HLC 26), a voltage and a frequency of the voltage of electric power received by the HLC 26 from a contact wire 22 via a pantograph 18 of a railway car. The bounce circuit 118 may compare the voltage with a voltage threshold and the frequency of the voltage with a frequency threshold. The bounce circuit 118 may determine an occurrence of a bounce event in a connection between the pantograph 18 and the contact wire 22, responsive to the voltage satisfying the voltage threshold and the frequency satisfying the frequency threshold for a time exceeding a threshold period of time. The bounce circuit 118 may disable, in response to determining the occurrence of the bounce event, a rectifier of the HLC 26.

In some embodiments, the bounce circuit 118 may determine, responsive to disabling the rectifier, that a root-mean-squared (RMS) voltage is greater than a RMS voltage threshold and that the frequency is within a target range. In some embodiments, the bounce circuit 118 may set, responsive to determining that the RMS voltage is greater than the RMS voltage threshold and the frequency is within the target range, the rectifier to a reference voltage using an instantaneous DC link voltage at the input of the HLC 26, to transition from the reference voltage to a nominal voltage.

In some embodiments, the bounce circuit 118 may determine, responsive to disabling the rectifier, that a root-mean-squared (RMS) voltage is less than or equal to a RMS voltage threshold or that the frequency is outside a target range. In some embodiments, the bounce circuit 118 may wait, responsive to determining that the RMS voltage is less than or equal to the RMS voltage threshold or the frequency is outside the target range, for a period of time for the frequency to become greater than a second frequency.

In some embodiments, the bounce circuit 118 may reset, responsive to setting the rectifier to a reference voltage based on an instantaneous DC link voltage, a plurality of control loops of the rectifier. In some embodiments, the bounce circuit 118 may enable, responsive to resetting of the plurality of control loops, the rectifier of the HLC 26 to continue operations.

In some embodiments, the bounce circuit 118 may determine, responsive to disabling the rectifier of the HLC 26, that a root-mean-squared (RMS) voltage is greater than a RMS voltage threshold and that the frequency is less than or equal to a second frequency threshold. In some embodiments, the bounce circuit 118 may cause, responsive to determining that the RMS voltage is greater than the RMS voltage threshold and that the frequency is less than the second frequency threshold, the HLC 26 to shut down.

In some embodiments, the bounce circuit 118 may determine, responsive to disabling the rectifier, that a root-mean-squared (RMS) voltage drops to less than a RMS voltage threshold and that the frequency becomes within a target range, within a period of time. In some embodiments, the bounce circuit 118 may resume, responsive to determining that the RMS voltage drops to less than the RMS voltage threshold and that the frequency becomes within the target range within the period of time, operations of the HLC 26.

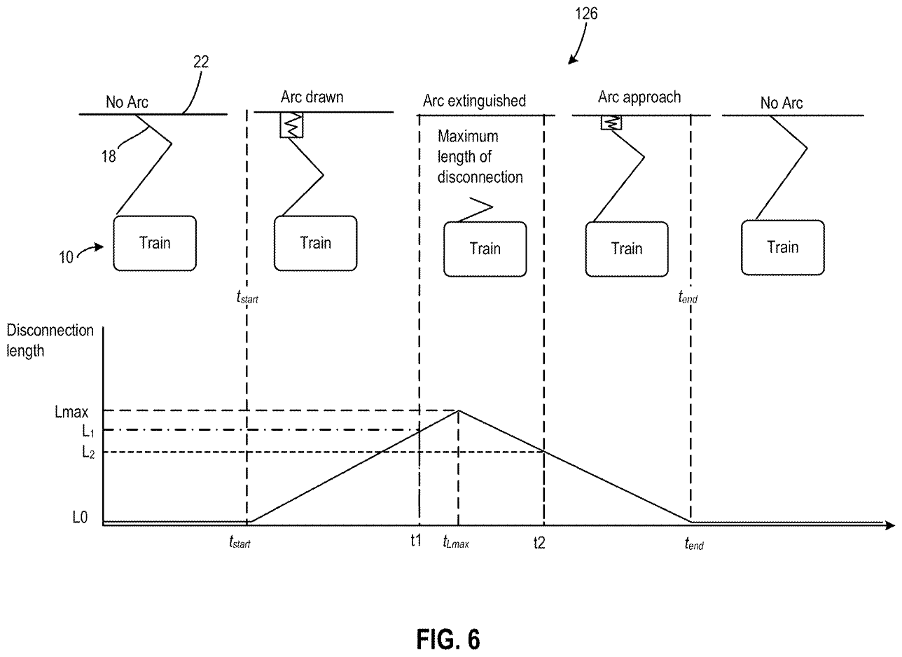

As shown in FIG. 6, pantograph bounce is an event that occurs as the railway car 10 moves along a railway because of rails joints, junction points or uneven rail surfaces. These or other rail inconsistencies can lead to increases in a distance between pantograph 18 and the contact wire 22. FIG. 6 depicts a pantograph bounce event 126. Communication of power between the contact wire 22 and the pantograph 18 depends on the distance between the pantograph 18 and the contact wire 22. Three modes of operation are shown in pantograph bounce event 126 and each mode is based on the distance or disconnection length between the pantograph 18 and the contact wire 22. The controller 34 (or the bounce circuit 118) may configure the HLC 26 to operate in accordance with one of the modes of operations, in response to detecting the pantograph bounce event 126.

In an arc drawn mode, the disconnect length is between L0 at a start time tstart and L1 at a first time t₁. In the arc drawn mode, input voltage is still received by the pantograph 18 from the contact wire 22. The controller 34 may identify or determine whether a time elapsed since the first detection of the pantograph event 126 is less than a threshold time. The threshold time may delineate, identify, or define an amount of time at which to cause the HLC 26 to maintain the arc drawn mode. If the elapsed is less than the threshold, the controller 34 may determine to perform the arc drawn mode. Under the arc drawn mode, the controller 34 (or the bounce circuit 118) may configure or cause the HLC 26 to draw the electric power via the pantograph 18 from the contact wire 22, even while disconnected therefrom via an electric arc formed between the pantograph 18 and the contact wire 22.

In an arc extinguished mode, the disconnect length is between L1 at the first time t1 to Lmax at a max disconnect time t_{Lmax}, and between Lmax at the max disconnect time t_{Lmax} and L2 at a second time t₂. In the arc extinguished mode, no input voltage is received by the pantograph 18 as complete electrical disconnection has occurred. The controller 34 may identify or determine whether the time elapsed since the first detection of the pantograph event 126 is greater than or equal to a threshold time. The threshold time may delineate, identify, or define an amount of time at which to cause the HLC 26 to switch from the arc drawn mode to the arc extinguished mode. If the elapsed is greater than or equal to the threshold, the controller 34 may determine to perform the arc extinction mode, and to switch from the arc drawn mode. Under the arc extinction mode, the controller 34 (or the bounce circuit 118) may configure or cause the HLC 26 to not or refrain drawing the electric power from the pantograph 18 while disconnected from the contact wire 22. The controller 34 may cause the HLC 26 to actively suppress the electric arc between the pantograph 18 and the contact wire 22 by breaking the electrical connection.

In an arc approach mode, the disconnect length is between L2 at the second time t₂ to L0 at an end time tend and input voltage is reestablished at the pantograph 18. The controller 34 may identify, detect, or otherwise detect reestablishment of the connection between the pantograph 18 and the contact wire 22, subsequent to the first detection of the pantograph bounce event 126. The reestablishment may occur while the pantograph 18 is not physical contact with the contact wire 22. Upon detection, the controller 34 may determine to perform the arc approach mode, and to switch from the arc extinction mode. Under the arc approach mode, the controller 34 (or the bounce circuit 118) may configure or cause the HLC 26 to draw the electric power from the pantograph 18. The pantograph bounce event defines a total bounce time between the start time tstart and the end time tend.

The HLC 26 is Head-on-Generation (HOG) operated and it is desirable for the HLC 26 to deliver uninterrupted power/energy during the pantograph bounce event. Additionally, equipment protection and product reliability is important during the pantograph bounce event. The pantograph bounce event, may cause high voltage and current transients, HLC 26 malfunctions (e.g., requiring a service call) and may lead to HLC 26 critical component failures and degradations and power/energy interrupt to end user.

The pantograph bounce login is initialized. If the zero cross frequency of input voltage (FVin) is greater than an input voltage frequency threshold (e.g., 700 Hz) and a root mean square input voltage (Vin) is greater than an input voltage threshold (e.g., 100 Vrms) then the bounce circuit 118 determines that a pantograph bounce event 126 is occurring. A sense time delay is implemented. In some embodiments, the sense time is about fifteen milliseconds (~15 mS). During the sense time, the bounce circuit 118 continues to monitor the zero cross frequency of input voltage (FVin) and the root mean square input voltage (Vin).

If the zero cross frequency of input voltage (FVin) is not greater than the input voltage frequency threshold (e.g., 700 Hz) or the root mean square input voltage (Vin) is not greater than an input voltage threshold (e.g., 100 Vrms) then, the bounce circuit 118 does not confirm a pantograph bounce event 126 and normal HLC 26 operation is continued. If the zero cross frequency of input voltage (FVin) is greater than the input voltage frequency threshold (e.g., 700 Hz), the root mean square input voltage (Vin) is greater than the input voltage threshold (e.g., 100 Vrms), and the sense time has elapsed, then the bounce circuit 118 confirms the pantograph bounce event 126 and the bounce circuit 118 immediately disables the rectifier 82. In some embodiments, the rectifier 82 is disabled via a rectifier IGBT pulse width modulation driver (PWM) for one and a half line cycles or about thirty milliseconds (30 mS).

The bounce circuit 118 compares an input voltage frequency (fVin) to a target value (e.g., ~50 hz (±5 Hz)), and the root mean square input voltage (Vin) compared to a threshold (e.g., 630 Vrms). If the input voltage frequency (fVin) equals the target value (e.g., ~50 hz (±5 Hz)), and the root mean square input voltage (Vin) is greater than the threshold (e.g., 630 Vrms), then the bounce circuit 118 measures an instantaneous DC link voltage. In some embodiments, the DC link voltage measured is then set as a corresponding reference to a rectifier voltage loop (outer loop). The reference is set because during the pantograph bounce event 126, the rectifier voltage can drop to 1000V or lower, and if the HLC 26 is started with a standard 1800V reference command (e.g., if 1800V is the HLC rectifier 82 nominal output voltage) then the HLC 26 will experience an overshoot of current as the converters will try to ramp voltage from ~1000V to 1800V.

In some embodiments, measuring instantaneous DC link voltage, the bounce circuit 118 can set a reference corresponding to the available DC voltage (e.g., 1000V) and then ramp from the 1000V reference to the 1800V nominal voltage with a soft start ramp to avoid overshoot and to ensure power component functionality. Then, control loops of the rectifier 82 and/or other power electronics are reset. In some embodiments, the reset control loops include anti-windup/reset features. The rest is applied to the rectifier IGBTs at a next coming zero cross of input voltage (e.g, a 1 mS to a 10 mS delay). Therefore, in some embodiments, the total bounce time could be limited to between about 41 mS and about 50 mS (e.g., 15 ms+30 ms+(~1 ms to 10 mS).

If the input voltage frequency (fVin) does not equals the target value (e.g., ~50 hz (±5 Hz)), or the root mean square input voltage (Vin) is not greater than the threshold (e.g., 630 Vrms), the input voltage frequency (FVin) is compared to a threshold and the root mean square input voltage (Vin) is compared to a threshold. If the input voltage frequency (FVin) is greater than the threshold (e.g., 700 Hz) and the root mean square input voltage (Vin) is less than the threshold (e.g., 630 Vrms), then wait (with the rectifier 82 PWM Off) for a threshold time (e.g., 120 mS). If the input voltage frequency (FVin) is not greater than the threshold (e.g., 700 Hz) and the root mean square input voltage (Vin) is not less than the threshold (e.g., 630 Vrms), then the pantograph bounce event 126 has resulted in no voltage being supplied to the pantograph 18 for too long a period and NO VOLTAGE is displayed on the HMI 42 and protection and/or shut down procedures are activated.

When the bounce circuit 118 is waiting to elapse the threshold time, the bounce circuit 118 continues to monitor the input voltage frequency (fVin). If at any time during the waiting period (e.g., between 30 mS and 120 mS), the input voltage frequency (fVin) returns to the target (e.g., ~50 hz (±5 Hz)). If the input voltage frequency (FVin) is greater than the threshold (e.g., 700 Hz) for more than the waiting period (e.g., 120 mS), then the bounce circuit 118 displays NO VOLTAGE and executes a systematic shutdown sequence. The pantograph bounce logic provides no power interruption to the end use for a specified total bounce time (e.g., 45 mS), no overshoot/undershoot during the pantograph bounce event 126, and no stress to the power electronics of the HLC 26 during the pantograph bounce event.

The bounce circuit 118 described above is one example of a pantograph bounce logic system that includes one or more processing circuits comprising one or more memory devices coupled to one or more processors, the one or more memory devices configured to store instructions thereon that, when executed by the one or more processors, cause the one or more processors to: determine a pantograph bounce event based on an input voltage and an input voltage frequency, automatically disable a rectifier in response to determining the pantograph bounce event, record a DC link voltage at the time the rectifier is disabled, and set a reference DC voltage to the DC link voltage. In some embodiments, the one or more memory devices are further configured to store instructions thereon that, when executed by the one or more processors, cause the one or more processors to determine the pantograph bounce event based on the input voltage and the input voltage frequency after a sense time has elapsed. In some embodiments, the one or more memory devices are further configured to store instructions thereon that, when executed by the one or more processors, cause the one or more processors to determine, in response to disabling the rectifier, that an input voltage frequency is not equal to a target frequency, transmit a message indicating no input voltage is received, and initiate a shutdown sequence. In some embodiments, the one or more memory devices are further configured to store instructions thereon that, when executed by the one or more processors, cause the one or more processors to operate the rectifier to provide a soft ramp of voltage from the reference DC voltage to a nominal voltage.

The pantograph bounce logic system in the form of the bounce circuit 118 can implement concepts described herein to protect components of the HLC 26 that can be affected if a systematic turn on sequence is not executed along with a power interrupt to end customer. Exemplary components of the HLC 26 that can be protected include an input contactor positioned between the main transformer 78 and the rectifier 82, a pre-charge contactor, a pre-charge resistor, IGBT modules of both the inverter 86 and rectifier 82, DC link capacitors, an input inductor, a DC filter capacitor, inverter L and C filters, and output contactors.

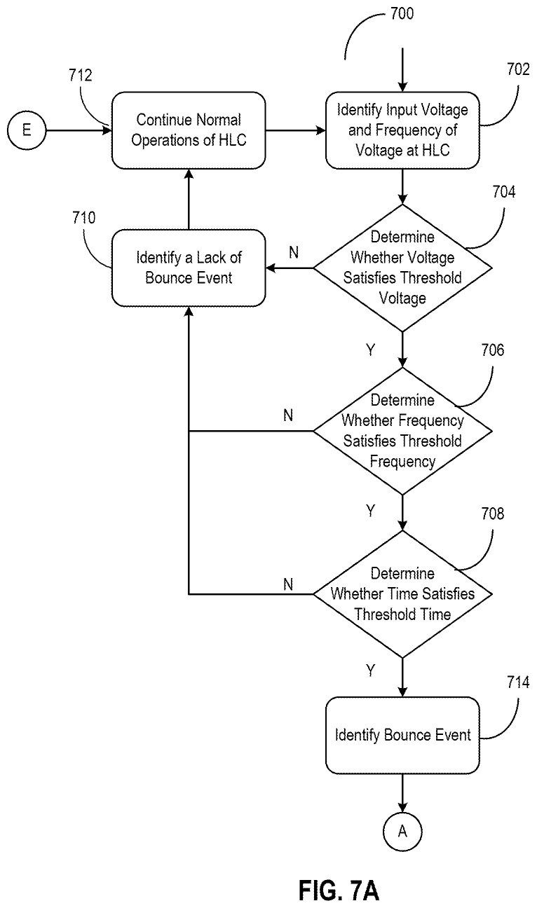

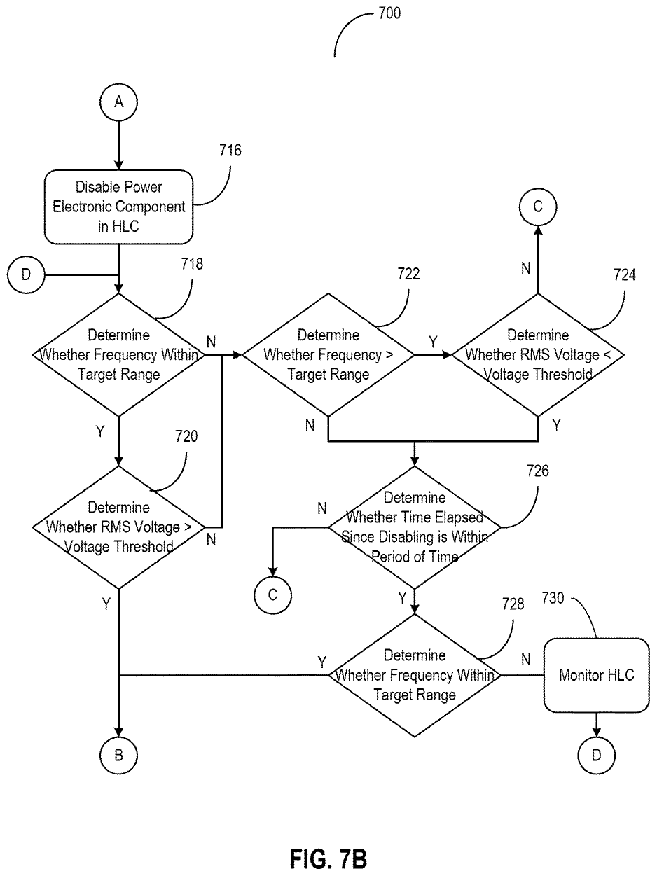

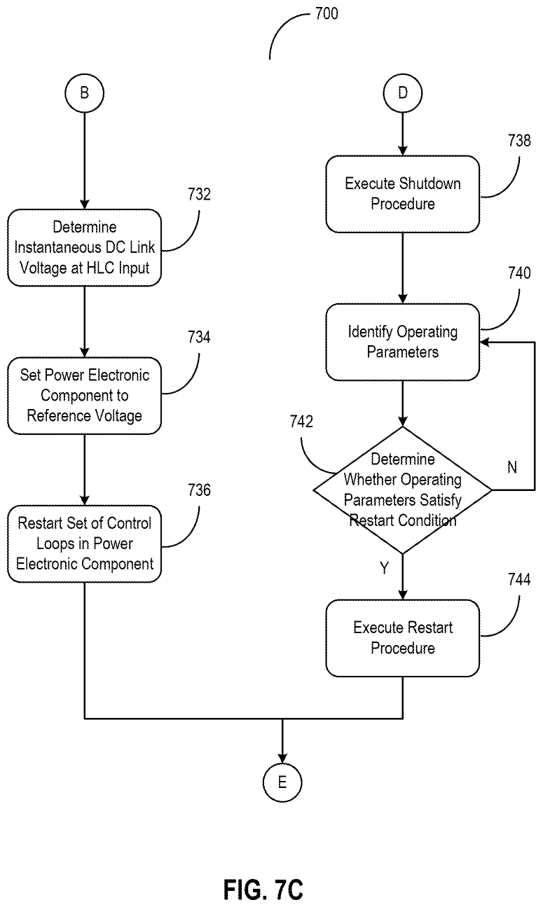

Referring now to FIGS. 7A-C, depicted is a flow diagram of a method 700 of providing continuous power through pantograph bounce events. The method 700 may be implemented or performed using any of the components described herein, such as the controller 34, the bounce circuit 118, and the HLC 26 of the system 35. When performing the steps of method 700, one or more steps may be omitted. Under the method 700, at step 702, a controller (e.g., the controller 34) may measure, monitor, or otherwise identify an input voltage and a frequency of the input voltage at a hotel load converter (HLC) (e.g., the HLC 26). The input voltage and the frequency of the voltage may be of the electric power received from a contact wire via a pantograph of a railway car to be conveyed through a power electronic components (e.g., the rectifier 32) of the HLC. The pantograph may be structured to be electrically coupled with the electric power from the contact wire outside the railway car. The HLC may be structured to be electrically coupled with the pantograph to accept the conveyance of electric power. In some embodiments, the electric power may be of alternating current (AC) form. The controller may determine, measure, or otherwise identify a voltage alternating current (VAC) or a root-mean-square (RMS) voltage of the electric power from the pantograph. In some embodiments, the controller may determine, measure, or otherwise identify a frequency of zero crossings of the voltage of the electrical power. The RMS voltage may be used as the voltage and the frequency of zero crossings may be used as the frequency.

At step 704, the controller may identify or determine whether the input voltage satisfies a threshold voltage. The threshold voltage may delineate, identify, or otherwise define a value for the input voltage corresponding to a potential pantograph bounce event (e.g., the pantograph bounce event 22) in a connection between the pantograph of the railway car and the contact wire. The controller may compare the input voltage (e.g., RMS voltage) with the threshold voltage (e.g., a value for the RMS voltage). If the input voltage is less than the threshold voltage, the controller may determine that the input voltage does not satisfy the threshold voltage. Otherwise, if the input voltage is greater than or equal to the threshold voltage, the controller may determine that the input voltage satisfies the threshold voltage.

At step 706, the controller may identify or determine whether the frequency of the input voltage satisfies a threshold frequency. The threshold frequency may delineate, identify, or otherwise define a value for the input frequency corresponding to a potential pantograph bounce event in the connection between the pantograph of the railway car and the contact wire. The controller may compare the input frequency (e.g., the zero-crossing frequency) with the threshold frequency (e.g., a value for the zero-crossing frequency). If the input frequency is less than the threshold frequency, the controller may determine that the input frequency does not satisfy the threshold frequency. Otherwise, if the input frequency is greater than or equal to the threshold frequency, the controller may determine that the input frequency satisfies the threshold frequency

At step 708, the controller may identify or determine whether a time satisfies a threshold time. The time may correspond to an amount of time elapsed since the first detection of the input voltage satisfying the threshold voltage or the frequency satisfying the threshold frequency, or both. The controller may activate or start a timer to keep track of the amount of time elapsed since the first detection. From the timer, the controller may measure or identify the time elapsed since the first detection of the input voltage satisfying the threshold voltage or the frequency satisfying the threshold frequency, or both. With the identification, the controller may compare the time with a threshold period of time. The threshold period of time may correspond a value for the time corresponding to a potential pantograph bounce event in the connection between the pantograph of the railway car and the contact wire. If the time does not exceed the threshold period of time, the controller may determine that the time fails to satisfy the threshold period of time. Otherwise, if the time exceeds the threshold period of time, the controller may determine that the time satisfies the threshold period of time. In some embodiments, the step 708 may be omitted from method 700.

At step 710, when the voltage fails to satisfy the threshold voltage, the frequency fails to satisfy the threshold frequency, or the time fails to satisfy the threshold time, the controller may detect, determine, or otherwise identify an absence or a lack of the bounce event. In some embodiments, the controller may identify the absence or the lack of occurrence of the bounce event in the connection between the pantograph of the railway car and the contact wire. At step 712, the controller may continue normal operations of the HLC. With the identification of the lack of the bounce event in the connection between pantograph of the railway car and the contact wire, the controller may continue the normal operations of the power electronic components in the HLC. Under normal operations, the HLC may deliver, convey, or otherwise provide the electric power to at least one load on the railway car. The load may include, for example, at least one of: an entertainment system, a kitchen appliance, a personal electronic device, a refrigeration system, a heating system for the railway car. In some embodiments, the loads may include propulsion components within the railway car.

In some embodiments, the method 700 may include determining, by the controller, that the voltage does not satisfy the voltage threshold and frequency does not satisfy the frequency threshold. In some embodiments, the method 700 may include identifying, by the controller, a lack of the bounce event in the connection between the pantograph and the contact wire based on the voltage not satisfying the voltage threshold and the frequency not satisfying the frequency threshold. In some embodiments, the method 700 may include continuing, by the controller, responsive to identifying the lack of the bounce event, operations of the power electronic component in the HLC.

At step 714, when the voltage satisfies the threshold voltage, the frequency satisfies the threshold frequency, and the time satisfies the threshold time, the controller may detect, determine, or otherwise identify an occurrence of the bounce event. The bounce event may be in the connection between the pantograph of the railway car and the contact wire. In some embodiments, when the voltage satisfies the threshold voltage and the frequency satisfies the threshold frequency, the controller may detect or identify the occurrence of the bounce event.

In some embodiments, the method 700 may include monitoring, by a controller, at an input of a hotel load converter (HLC), a voltage and a frequency of the voltage of electric power received via a pantograph from a contact wire. The method 700 may include determining, by the controller, that the voltage satisfies a voltage threshold and the frequency satisfies a frequency threshold. The method 700 may include detecting, by the controller, a bounce event in a connection between the pantograph and the contact wire, responsive to determining the voltage satisfying the voltage threshold and the frequency satisfying the frequency threshold. The method 700 may include performing, by the controller, responsive to detecting the bounce event, an operation on a power electronic component in the HLC.

In some embodiments, the method 700 may include determining, by the controller, that a time elapsed since detection of the bounce event is less than a threshold time. In some embodiments, performing the operation may include performing an arc drawn mode to draw the electric power via the pantograph from the contact wire, responsive to determining that the time elapsed is less than the threshold time.

In some embodiments, the controller may command, set, or otherwise configure the HLC to operate in accordance with a set of operation modes (e.g., as depicted in FIG. 6) based on whether the bounce event is detected between the pantograph of the railway car and the contact wire. In some embodiments, the controller may configure the HLC according to the set of operating modes based at least on (i) a distance between the pantograph and the contact wire, (ii) the voltage or frequency at the input of the HLC, or (iii) time elapsed since detection of the bounce event. The distance may correspond to a distance of an electric arc between the pantograph and the contact wire, and may be determined as a function (e.g., Paschen's curve). The operating modes may include an arc drawn mode, an arc extinction mode, and an arc approach mode, among others.

The controller may identify or determine whether a time elapsed since the first detection of the pantograph event is less than a threshold time. The threshold time may delineate, identify, or define an amount of time at which to cause the HLC to maintain the arc drawn mode. If the elapsed is less than the threshold, the controller may determine to perform the arc drawn mode. Under the arc drawn mode, the controller may configure or cause the HLC to draw the electric power via the pantograph from the contact wire, even while disconnected therefrom via an electric arc formed between the pantograph and the contact wire. If the elapsed is greater than or equal to the threshold, the controller may determine to perform the arc extinction mode, and to switch from the arc drawn mode. Under the arc extinction mode, the controller may configure or cause the HLC to not or refrain drawing the electric power from the pantograph while disconnected from the contact wire. The controller may cause the HLC to actively suppress the electric arc between the pantograph and the contact wire by breaking the electrical connection. Upon detection of the reestablishment of the connection between the pantograph and the contact wire, the controller may determine to perform the arc approach mode, and to switch from the arc extinction mode. Under the arc approach mode, the controller may configure or cause the HLC to draw the electric power from the pantograph.

In some embodiments, the method 700 may include determining, by the controller, that a time elapsed since detection of the bounce event is greater than or equal to a threshold time. In some embodiments, performing the operation may include performing an arc extinction mode to not draw the electric power via the pantograph from the contact wire, responsive to determining that the time elapsed is greater than or equal to the threshold time.

In some embodiments, the method 700 may include detecting, by the controller, subsequent to detecting the bounce event, reestablishment of the connection between the pantograph and the contact wire. In some embodiments, the method 700 may include performing, by the controller, an arc approach mode to draw the electric power via the pantograph from the contact wire, responsive to detecting the reestablishment of the connection subsequent to the bounce event.

At step 716, with the detection or identification of the bounce event, the controller may deactivate, turn off, or otherwise disable the power electronic component (e.g., the rectifier 82) in the HLC. In some embodiments, the controller may disable the rectifier in the HLC, upon identifying the bounce event in the connection between the pantograph of the railway car and the contact wire. With the disabling, the controller may measure, identify, or otherwise monitor the input voltage and the frequency of the voltage of the electric power at the input of the HLC. In some embodiments, the controller may measure the voltage and the frequency of the voltage of the electric power to be conveyed through the power electric component (e.g., the rectifier). In some embodiments, the electric power may be of alternating current (AC) form. The controller may determine, measure, or otherwise identify a voltage alternating current (VAC) or a root-mean-square (RMS) voltage of the electric power from the pantograph. In some embodiments, the controller may determine, measure, or otherwise identify a frequency of zero crossings of the voltage of the electrical power. The RMS voltage may be used as the voltage and the frequency of zero crossings may be used as the frequency.

At step 718, with the disabling of the power electronic component in the HLC, the controller may identify or determine whether the frequency of the voltage is within a target range. The target range may delineate, identify, or otherwise define an upper limit and a lower limit of the expected values for the frequency of the voltage of the electric power, corresponding to a condition in which to restart the normal operations of the HLC. The controller may compare the frequency with the target range. If the frequency of the voltage is lower than or more than the target range, the controller may determine that the frequency is outside the target range. If the frequency of the voltage is higher than the lower limit and less than the upper limit of the target range, the controller may determine that the frequency is within the target range. In some embodiments, the step 718 may be omitted from method 700.

At step 720, the controller may identify or determine whether the input RMS voltage (or VAC) is greater than a voltage threshold. The controller may perform the determination, when the target range is within the target range. The voltage threshold may delineate, define, or identify a value of the input RMS voltage corresponding to a condition in which to restart the normal operations of the HLC. The controller may compare the input RMS voltage with the voltage threshold. If the RMS voltage is greater than the threshold voltage, the controller may determine that the RSM voltage is greater than the threshold voltage. If the RMS voltage is less than or equal the voltage threshold, the controller may determine that the RMS voltage is less than or equal than the voltage threshold. In some embodiments, the step 720 may be omitted from method 700

At step 722, the controller may identify or determine whether the frequency is greater than the target range. The controller may perform the determination, when the frequency is determined to be outside the target range or the when the RMS voltage is less than or equal to the voltage threshold. The controller may compare the frequency to the target range (e.g., the upper and lower limits). When the frequency of the voltage is less than or equal to the lower limit of the target range, the controller may determine that the frequency of the voltage is less than the target range. When the frequency of the frequency of the voltage is greater than the upper limit of the target range, the controller may determine that the frequency of the voltage is greater than the target range. In some embodiments, the step 722 may be omitted from method 700

At step 724, the controller may identify or determine whether the input RMS voltage is less than a voltage threshold. The controller may perform the determination, when the frequency of the voltage of the electric power is determined to be greater than the target range. The controller may compare the input RMS voltage with the voltage threshold. The voltage threshold may be the same as or different from the voltage threshold of step 720, and may delineate, define, or identify a value of the input RMS voltage corresponding to when to initiate shut down procedure. When the RMS voltage is greater than the voltage threshold, the controller may determine that the RMS voltage is greater than the voltage threshold. The controller may determine to proceed to shut down procedure. When the RMS voltage is less than or equal to the voltage threshold, the controller may determine that the RMS voltage is less than or equal to the voltage threshold. In some embodiments, the step 724 may be omitted from method 700

At step 726, the controller may identify or determine whether a time elapsed since the disabling of the power electronic component is within a threshold period of time. The controller may maintain a timer to keep track of time elapsed since the disablement of the power electronic component (e.g., the rectifier) in the HLC. The threshold period of time may correspond to a value of the time within which the voltage and frequency are expected to be within the respective thresholds to resume normal operations of the HLC. The controller may compare the time with threshold time of period. When the time is less than the threshold period of time, the controller may determine that the time is less than or within the threshold period of time. When the time is greater than the threshold period of time, the controller may determine that the time is greater than or outside the threshold period of time, and may proceed to shut down procedure. In some embodiments, the step 726 may be omitted from method 700

At step 728, the controller may identify or determine whether the frequency is within the target range. The controller may perform the determination of whether the frequency is within the target range, when the time elapsed is determined to be within the period of time. The step operations of step 728 may be similar to the operations of step 718. The target range may delineate, identify, or otherwise define an upper limit and a lower limit of the expected values for the frequency of the voltage of the electric power, corresponding to a condition in which to restart the normal operations of the HLC. The controller may compare the frequency with the target range. If the frequency of the voltage is lower than or more than the target range, the controller may determine that the frequency is outside the target range. If the frequency of the voltage is higher than the lower limit and less than the upper limit of the target range, the controller may determine that the frequency is within the target range. While the RMS voltage is greater than the voltage threshold or the frequency is outside within target range during the threshold period of time, the controller may wait for the threshold period of time. The controller may initiate resumption of the HLC, with the determination that the RMS voltage drops less than the voltage threshold and the frequency becomes within targe range within the threshold period of time. In some embodiments, the step 728 may be omitted from method 700.

At step 730, when the frequency is not within the target range while within the target range, the controller may measure, identify, or otherwise monitor the input at the HLC. In some embodiments, the controller may measure the voltage and the frequency of the voltage of the electric power to be conveyed through the power electric component (e.g., the rectifier) of the HLC. In some embodiments, the electric power may be of alternating current (AC) form. The controller may determine, measure, or otherwise identify a voltage alternating current (VAC) or a root-mean-square (RMS) voltage of the electric power from the pantograph. In some embodiments, the controller may determine, measure, or otherwise identify a frequency of zero crossings of the voltage of the electrical power. The RMS voltage may be used as the voltage and the frequency of zero crossings may be used as the frequency. The controller may repeat the method 700 from step 718. In some embodiments, the step 730 may be omitted from method 700

At step 732, the controller may calculate, measure, or otherwise determine an instantaneous direct current (DC) link voltage at the input of the HLC or the power electronic component in the HLC. The controller may perform the determination, when the frequency is within the target range and the RMS voltage is greater than the voltage threshold. The controller may also perform the determination, when the frequency becomes within the target range and the RMS voltage becomes less than the voltage threshold within the threshold period of time. The instantaneous DC link voltage may correspond to a DC voltage in a DC link (e.g., the connection between the rectifier and the inverter) in the HLC.

At step 734, the controller may assign, configure, or otherwise set the power electronic component the HLC to a reference voltage. In setting, the controller may calculate or determine a reference voltage using the instantaneous DC link voltage. The reference voltage may define a level of voltage to function or serve as a setpoint for the output voltage of the power electronic component. The setting using the instantaneous DC link voltage may be used to transition the power electronic component from the reference voltage to a normal voltage. In some embodiments, the controller may use the instantaneous DC link voltage as the reference voltage. In some embodiments, the controller may determine the reference voltage as a function of the instantaneous DC link voltage. With the setting, the controller may initiate restarting of normal operations of the power electronic component of the HLC.

At step 736, the controller may refresh, reconfigure, or otherwise reset a set of control loops in the power electronic component in the HLC. The power electronic component (e.g., the rectifier) may include the set of control loops to manage or regulate output characteristics, such as the voltage and current. The set of control loops may take output voltage and input voltage as feedback to maintain output voltage relatively constant, independent of variance of input voltage and output load current. The bounce event may have caused no input voltage feedback to control loop causing maximum errors in control loops between reference value and feedback value which make control loop output maximum. This may lead to very high duty cycle to components there by very high inrush currents or transients resulting in the system interrupt, shutdown, failures during rectifier restart. With the resetting of the set of control loops, the controller may activate, restart, or otherwise enable the power electronic component, the controller may perform a soft start (or soft ramp) of the power electronic component in the HLC. For example, the controller may configure the set of control loops in the power electronic component in the HLC to output a zero duty cycle to initiate a soft start of the power electronic component. The controller may repeat the method 700 from the step 712 to resume normal operations in the HLC.

In some embodiments, the method 700 may include resetting, by the controller, responsive to setting the power electronic component to a reference voltage based on an instantaneous direct current (DC) link voltage at the input of the HLC, a plurality of control loops of the power electronic component. In some embodiments, the method 700 may include enabling, by the controller, responsive to resetting of the plurality of control loops, the HLC to continue operations.

At step 738, the controller may perform, carry out, or otherwise execute a shutdown procedure on the HLC. The controller may initiate the execution of the shutdown procedure, when the frequency is outside the target range and the input voltage is greater than the voltage threshold. In some embodiments, the controller may initiate the execution of the shutdown procedure, when the frequency remains outside the target range and the input voltage remains greater than the voltage threshold past the threshold period of time. In some embodiments, the controller may cause the HLC to shut down. To shut down, the controller may open or disconnect the connection between the HLC and the pantograph, and other power sources on the railway car. In some embodiments, the controller may also open or disconnect the connection between the HLC and the load in the railway car.

At step 740, the controller may monitor, measure, or otherwise identify a set of operating parameters, with the execution of the shutdown procedure. The set of operating parameters may include voltage, current, power, temperature or other characteristics of the HLC and the power electronic components therein. The controller may measure the set of operating parameters from one or more sensors on the power electronic components of the HLC. In some embodiments, the step 740 may be omitted from method 700. At step 742, the controller may determine whether the set of operating parameters of the HLC with a restart condition. The restart condition may define or identify values of the operating parameters at which to restart the HLC and the power electronic components therein. If the operating parameters do not satisfy the restart condition, the controller may repeat step 740 and continue monitoring the set of operating parameters of the HLC. In some embodiments, the step 742 may be omitted from method 700. At step 744, If the operating parameters satisfy the restart condition, the controller may perform, carry out, or otherwise execute the restart procedure for the HLC. The controller may execute the restart procedure by reconnecting the HLC with the pantograph and other power sources on the railway. In some embodiments, the controller may re-establish the connection between the HLC and the load on the railway car. The controller may repeat the method 700 from the step 712 to resume normal operations in the HLC.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While various circuits with particular functionality are shown in FIGS. 5-7, it should be understood that the controller 34 may include any number of circuits for completing the functions described herein. For example, the activities and functionalities of the bounce circuit 118 may be combined in multiple circuits or as a single circuit. Additional circuits with additional functionality may also be included. Further, the controller 34 may further control other activity beyond the scope of the present disclosure.

As mentioned above and in one configuration, the “circuits” may be implemented in machine-readable medium for execution by various types of processors, such as the processor 106 of FIG. 5. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the HLC 26 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A system for protecting from pantograph bounce events, comprising:
a pantograph disposed on a railway car, the pantograph structured to be electrically coupled with a contact wire to receive electric power from the contact wire;
a hotel load converter (HLC) disposed in the railway car, the HLC structured to be electrically coupled with the pantograph, the HLC comprising a power electronic component configured to perform alternating current (AC/AC) conversion on the electric power received via the contact wire from the railway car; and
a controller disposed in the railway car, the controller structured to be electrically coupled with the HLC, the controller comprising a bounce circuit configured to:
identify, at an input of the HLC, a voltage and a frequency of the voltage of the electric power from the pantograph;
determine that the voltage satisfies a voltage threshold and the frequency satisfies a frequency threshold;
detect a bounce event in a connection between the pantograph and the contact wire providing the electric power based on the voltage satisfying the voltage threshold and the frequency satisfying the frequency threshold; and
disable, responsive to detecting the bounce event, the power electronic component in the HLC.

2. The system of claim 1, wherein the controller is further configured to:
determine, responsive to disabling the power electronic component, an instantaneous direct current (DC) link voltage at the input of the HLC; and
set the power electronic component to a reference voltage using the instantaneous DC link voltage to continue operations of the power electronic component.

3. The system of claim 1, wherein the controller is further configured to:
determine, responsive to disabling the power electronic component, that a root-mean-squared (RMS) voltage is greater than a RMS voltage threshold and that the frequency is less than or equal to a second frequency threshold; and
execute, responsive to determining that the RMS voltage is greater than the RMS voltage threshold and that the frequency is less than the second frequency threshold, a shutdown procedure on the HLC.

4. The system of claim 1, wherein the controller is further configured to:
determine, responsive to disabling the power electronic component, that a root-mean-squared (RMS) voltage drops to less than a RMS voltage threshold and that the frequency becomes within a target range, within a period of time; and
resume, responsive to determining that the RMS voltage drops to less than the RMS voltage threshold and that the frequency becomes within the target range within the period of time, operations of the HLC.

5. The system of claim 1, wherein the controller is further configured to:
determine that the voltage does not satisfy the voltage threshold and frequency does not satisfy the frequency threshold;
identify a lack of the bounce event in the connection between the pantograph and the contact wire based on the voltage not satisfying the voltage threshold and the frequency not satisfying the frequency threshold; and
continue, responsive to identifying the lack of the bounce event, operations of the power electronic component in the HLC.

6. The system of claim 1, wherein the HLC is further configured to operate in accordance with at least one of a plurality of modes based at least on (i) a distance between the pantograph and the contact wire and (ii) the voltage at the input of the HLC.

7. The system of claim 1, wherein the HLC is further configured to provide the electric power to a load on the railway car, wherein the load comprises at least one of: an entertainment system, a kitchen appliance, a refrigeration system, a heating system for the railway car.

8. A controller, comprising:
a bounce circuit comprising one or more processors coupled with memory, configured to:
monitor, at an input of a hotel load converter (HLC), a voltage and a frequency of the voltage of electric power received by the HLC from a contact wire via a pantograph of a railway car;
compare the voltage with a voltage threshold and the frequency of the voltage with a frequency threshold;
determine an occurrence of a bounce event in a connection between the pantograph and the contact wire, responsive to the voltage satisfying the voltage threshold and the frequency satisfying the frequency threshold for a time exceeding a threshold period of time; and
disable, in response to determining the occurrence of the bounce event, a rectifier of the HLC.

9. The controller of claim 8, wherein the bounce circuit is further configured to:
determine, responsive to disabling the rectifier, that a root-mean-squared (RMS) voltage is greater than an RMS voltage threshold and that the frequency is within a target range; and
set, responsive to determining that the RMS voltage is greater than the RMS voltage threshold and the frequency is within the target range, the rectifier to a reference voltage using an instantaneous DC link voltage at the input of the HLC, to transition from the reference voltage to a nominal voltage.

10. The controller of claim 8, wherein the bounce circuit is further configured to:
determine, responsive to disabling the rectifier, that a root-mean-squared (RMS) voltage is less than or equal to a RMS voltage threshold or that the frequency is outside a target range; and
wait, responsive to determining that the RMS voltage is less than or equal to the RMS voltage threshold or the frequency is outside the target range, for a period of time for the frequency to become greater than a second frequency.

11. The controller of claim 8, wherein the bounce circuit is further configured to:
reset, responsive to setting the rectifier to a reference voltage based on an instantaneous DC link voltage, a plurality of control loops of the rectifier; and
enable, responsive to resetting of the plurality of control loops, the rectifier of the HLC to continue operations.

12. The controller of claim 8, wherein the bounce circuitry circuit is further configured to:
determine, responsive to disabling the rectifier of the HLC, that a root-mean-squared (RMS) voltage is greater than a RMS voltage threshold and that the frequency is less than or equal to a second frequency threshold; and
cause, responsive to determining that the RMS voltage is greater than the RMS voltage threshold and that the frequency is less than the second frequency threshold, the HLC to shut down.

13. The controller of claim 8, wherein the bounce circuitry circuit is further configured to:
determine, subsequent to shutting down of the HLC, that a plurality of operating parameters of the HLC satisfy a restart condition; and
restart, responsive to determining that the plurality of operating parameters satisfy the restart condition, the HLC to receive the electric power from the contact wire via the pantograph.

14. The controller of claim 8, wherein the bounce circuitry circuit is further configured to:
determine, responsive to disabling the rectifier, that a root-mean-squared (RMS) voltage drops to less than a RMS voltage threshold and that the frequency becomes within a target range, within a period of time; and
resume, responsive to determining that the RMS voltage drops to less than the RMS voltage threshold and that the frequency becomes within the target range within the period of time, operations of the HLC.

15. The controller of claim 8, wherein the one or more processors and the memory of the bounce circuit are disposed in the HLC on the railway car.

16. A method of providing continuous power through pantograph bounce events, comprising:
monitoring, by a controller, at an input of a hotel load converter (HLC), a voltage and a frequency of the voltage of electric power received via a pantograph from a contact wire;
determining, by the controller, that the voltage satisfies a voltage threshold and the frequency satisfies a frequency threshold;
detecting, by the controller, a bounce event in a connection between the pantograph and the contact wire, responsive to determining the voltage satisfying the voltage threshold and the frequency satisfying the frequency threshold; and
performing, by the controller, responsive to detecting the bounce event, an operation on a power electronic component in the HLC.

17. The method of claim 16, further comprising determining, by the controller, that a time elapsed since detection of the bounce event is less than a threshold time; and
wherein performing the operation further comprising performing an arc drawn mode to draw the electric power via the pantograph from the contact wire, responsive to determining that the time elapsed is less than the threshold time.

18. The method of any of claim 16, further comprising determining, by the controller, that a time elapsed since detection of the bounce event is greater than or equal to a threshold time; and
wherein performing the operation further comprising performing an arc extinction mode to not draw the electric power via the pantograph from the contact wire, responsive to determining that the time elapsed is greater than or equal to the threshold time.

19. The method of claim 16, further comprising:
detecting, by the controller, subsequent to detecting the bounce event, reestablishment of the connection between the pantograph and the contact wire; and
performing, by the controller, an arc approach mode to draw the electric power via the pantograph from the contact wire, responsive to detecting the reestablishment of the connection subsequent to the bounce event.

20. The method of claim 16, further comprising:
resetting, by the controller, responsive to setting the power electronic component to a reference voltage based on an instantaneous direct current (DC) link voltage at the input of the HLC, a plurality of control loops of the power electronic component; and
enabling, by the controller, responsive to resetting of the plurality of control loops, the HLC to continue operations.

21. (canceled)
